(19) United States
(12) Patent Application Publication
(10) Pub. No.: US 2023/0054403 A1
(43) Pub. Date: Feb. 23, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Binhui LIU, Kanagawa (JP)

(73) Assignee: FUJIFILM Business Innovation Corp., Tokyo (JP)

(21) Appl. No.: 17/457,314

(22) Filed: Dec. 2, 2021

(30) Foreign Application Priority Data
Aug. 17, 2021 (JP) 2021-132911

(51) Int. Cl. H04N 1/00; G06F 1/3206

(52) U.S. Cl. CPC H04N 1/00896; H04N 1/00891; G06F 1/3206

(57) ABSTRACT

An information processing apparatus includes a processor configured to: receive a first time-designated operation setting to execute a first designated operation at a first designated time; and shift from a normal operation mode to a power saving mode based on an instruction, wherein the processor is configured to, if the first designated operation is not a predetermined operation, control to not return from the power saving mode to the normal operating mode to execute the first designated operation at arrival of the first designated time.

### CROSS-REFERENCE TO RELATED APPLICATIONS

This application is based on and claims priority under 35 USC 119 from Japanese Patent Application No. 2021-132911 filed Aug. 17, 2021.

### BACKGROUND

### (i) Technical Field

The present disclosure relates to an information processing apparatus, non-transitory computer readable medium, and information processing method.

### (ii) Related Art

Japanese Unexamined Patent Application Publication No. 2012-243219 discloses a computer device that stores information on previous power startup and is ready to perform quick startup using the information. The computer device includes a time measuring unit that measures time and generates an interrupt when a set time has arrived, a detector that detects whether a power-on instruction or a power-off instruction has been provided, a determination unit that, when the detector has detected the power-off, determines whether quick startup is enabled, and a setter that disables the interrupt generated by the time measuring unit when the determination unit determines that the quick startup is enabled.

If a time-designated operation command, such as a time-designated job, is performed in an information processing apparatus, such as a multi-function apparatus, the corresponding operation is performed in response to a notification received from a timer. Even while the information processing apparatus is in a power saving mode with at least a processor in a function-deactivated state, a timer function remains active to perform a time-designated operation command. When time designated in the time-designated operation command has arrived, the processor may return from the power saving mode and resume a normal operation mode in response to a notification from the timer.

In this configuration, the information processing apparatus returns from the power saving mode in response to any of the time-designated operation commands. This operation may be undesirable in the power saving point of view.

If the power saving is prioritized, the timer may be suspended during the power saving mode. A specific time-designated operation command that is performed even during the power saving mode may be difficult to perform.

### SUMMARY

Aspects of non-limiting embodiments of the present disclosure relate to providing an information processing apparatus, non-transitory computer readable medium, and information processing method reducing a frequency of a processor returning to a normal operation mode from a function halt mode in comparison with the case in which the processor automatically returns to a normal operation mode from a function halt mode to execute a set time-designated operation command when the time to execute the set time-designated operation command has arrived in a power saving mode.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above. According to an aspect of the present disclosure, there is provided an information processing apparatus including a processor configured to: receive a first time-designated operation setting to execute a first designated operation at a first designated time; and shift from a normal operation mode to a power saving mode based on an instruction, wherein the processor is configured to, if the first designated operation is not a predetermined operation, control to not return from the power saving mode to the normal operating mode to execute the first designated operation at arrival of the first designated time.

### BRIEF DESCRIPTION OF THE DRAWINGS

Exemplary embodiment of the present disclosure will be described in detail based on the following figures, wherein:

FIG. 1 illustrates a system configuration of an image forming system of an exemplary embodiment of the disclosure;

FIG. 2 is a block diagram illustrating a hardware configuration of an image forming apparatus of the exemplary embodiment of the disclosure;

FIG. 3 illustrates a setting table of time-designated operation commands of the image forming apparatus in accordance with the exemplary embodiment of the disclosure;

FIG. 4 illustrates a list of time-designated operation commands of the image forming apparatus in accordance with the exemplary embodiment of the disclosure;

FIG. 5 is a block diagram illustrating a process flow of the image forming apparatus in a power saving mode and a state in which a complex programmable logic device (CPLD) is set not to perform an interrupt request in response to a notification from a real-time clock (RTC);

FIG. 6 is a block diagram illustrating a process flow of the image forming apparatus in a power saving mode and a state in which the CPLD is set to perform an interrupt request in response to a notification from the RTC; and

FIG. 7 is a flowchart illustrating a process flow performed when a power button is pressed on the image forming apparatus.

### DETAILED DESCRIPTION

Exemplary embodiment of the disclosure is described in detail with reference to the drawings.

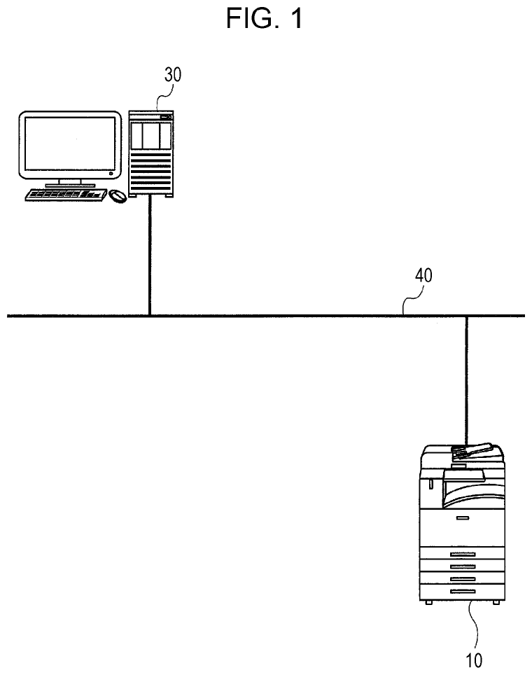

FIG. 1 illustrates a system configuration of an image forming system of the exemplary embodiment of the disclosure.

As illustrated in FIG. 1, the image forming system of the exemplary embodiment of the disclosure includes an image forming apparatus 10 and terminal device 30 interconnected to each other via a network 40. The terminal device 30 generates print data and transmits the generated print data to the image forming apparatus 10 via the network 40. The image forming apparatus 10 receives the print data from the terminal device 30 and outputs an image responsive to the print data onto a paper sheet. The image forming apparatus 10 is a multi-function apparatus having a print function, scan function, copy function, and fax function and is an example of an information processing apparatus of the exemplary embodiment of the disclosure.

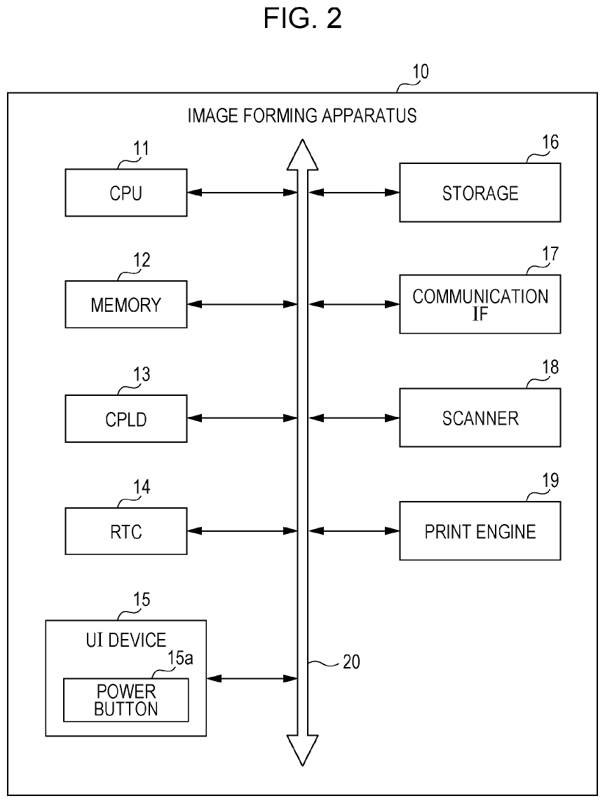

FIG. 2 illustrates a hardware configuration of the image forming apparatus 10 in the image forming system of the exemplary embodiment. Referring to FIG. 2, the image forming apparatus 10 includes a central processing unit (CPU) 11, memory 12, complex programmable logic device (CPLD) 13, real-time clock (RTC) 14, and user interface (UI) device 15. The image forming apparatus 10 further incudes a storage 16, such as a hard disk drive, communication interface (IF) 17 that transmits data to and receives data from an external apparatus, scanner 18, and print engine 19. These elements are interconnected to each other via a control bus 20.

The CPU 11 is a processor and controls the operation of the image forming apparatus 10 by performing a predetermined process in accordance with a control program stored on the storage 16. In the discussion of the exemplary embodiment, the CPU 11 reads and executes the control program stored on the memory 12 or the storage 16. The control program may be stored on a storage medium, such as a compact disc read-only memory (CD-ROM), and then delivered to the CPU 11.

The RTC 14 is an example of a timer and counts elapsed time. When set time has arrived, the RTC 14 transmits a notification. The CPLD 13 is an example of an interrupt request generator in the exemplary embodiment of the disclosure. The CPLD 13 receives a notification from the RTC 14 and performs an interrupt request to the CPU 11.

The UI device 15 includes a power button 15a combined with software and an operation panel having a touch panel. The operation panel displays a variety of information to a user and receives an operation from the user.

The communication IF 17 includes multiple communication interfaces that transmit data to and receive data from an external device, such as the network 40 or universal serial bus (USB). The scanner 18 reads a document image from a document that is set. The print engine 19 prints an image onto a recording medium, such as a print paper sheet, through charging, exposure, development, transfer, and fixing operations.

The types of operational status of the image forming apparatus 10 in the exemplary embodiment are described below. The image forming apparatus 10 of the exemplary embodiment includes a hardware switch (not illustrated). With the hardware switch turned off, the image forming apparatus 10 is powered off and thus in a fully deactivated state.

With the hardware switch turned on, the image forming apparatus 10 of the exemplary embodiment operates in one of three operational modes, namely, a power-off mode, normal operation mode, and power saving mode.

With the hardware switch (not illustrated) of the image forming apparatus 10 turned on, when the power button 15a is pressed on the image forming apparatus 10 in the power-off mode, the CPU 11 causes the image forming apparatus 10 to operate in the normal operation mode. If the power button 15a is long-pressed on the image forming apparatus 10 in the normal operation mode, the CPU 11 shifts the image forming apparatus 10 from the normal operation mode to the power-off mode. If the power button 15a is short-pressed with the image forming apparatus 10 in the normal operation mode, the CPU 11 shifts the image forming apparatus 10 from the normal operation mode to the power saving mode.

The long-pressing of the power button 15a signifies that the power button 15a is pressed continuously for a preset time period and the short-pressing of the power button 15a signifies that the power button 15a is continuously pressed for a time period shorter than the preset time period. For example, if the power button 15a is continuously pressed for 2 seconds or longer, the power button 15a is long-pressed. If the power button 15a is continuously pressed for a time period shorter than 2 seconds, the power button 15a is short-pressed.

The power-off mode signifies that supplying power, other than standby power used for the detection of the pressing of the power button 15a, is suspended to all the hardware forming the image forming apparatus 10 and that the operation of the image forming apparatus 10 is deactivated.

The normal operation mode signifies that the image forming apparatus 10 normally operates with power supplied to all the hardware forming the image forming apparatus 10. The CPU 11 is also in the normal operation mode when the image forming apparatus 10 is in the normal operation mode. When the power-off mode shifts to the normal operation mode, the CPU 11 is started at a default state. Specifically, the CPU 11 reads the control program from the storage 16 and loads the read control program onto the memory 12 and performs a predetermined process. The image forming apparatus 10 is now in the normal operation mode.

In the power saving mode, power is supplied to the memory 12, CPLD 13, RTC 14, and power button 15a of the UI device 15 and standby power used to receive an interrupt request is supplied to the CPU 11. Power is not supplied to the rest of the hardware, and the functions of the image forming apparatus 10 are deactivated. If the image forming apparatus 10 is in the power saving mode, the CPU 11 is also in the power saving mode with the functions thereof deactivated, namely, in a suspend mode.

Even in the middle of the execution of the control program, the CPU 11 may halt and shift into the suspend mode. In the power saving mode, the memory 12 continuously stores information down to the halt. When the CPU 11 returns to the normal operation mode from the suspend mode, the CPU 11 may perform quick startup using the information stored on the memory 12. The quick startup of the CPU 11 is typically referred to as quick boot. Specifically, time the CPU 11 takes to return from the suspend mode to the normal operation mode (time used for the quick boot) is shorter than time the CPU 11 takes to shift from the power-off mode to the normal operation mode.

If a time-designated operation command to execute a designated operation at a designated time is set, the CPU 11 sets the RTC 14 to time to execute the time-designated operation command.

In response to the reception of an instruction to shift to the power saving mode, the CPU 11 shifts to the power saving mode. In response to the reception of an interrupt request from the CPLD 13, the CPU 11 returns to the normal operation mode from the power saving mode and executes a time-designated operation command that is set.

If a specific time-designated operation command is not set when the instruction to shift to the power saving mode is received, the CPU 11 sets the CPLD 13 such that the CPLD 13 does not perform an interrupt request in response to a notification from the RTC 14. If the specific time-designated operation command is set, the CPU 11 sets the CPLD 13 such that the CPLD 13 performs the interrupt request in response to the notification from the RTC 14.

If the CPLD 13 is set not to perform an interrupt request in response to a notification from the RTC 14, the CPLD 13 does not perform the interrupt request to the CPU 11 even if the RTC 14 transmits the notification to the CPLD 13 when the designated time has arrived.

If the set time-designated operation commands do not include a specific time-designated operation command, the CPLD 13 is set not to perform the interrupt request in response to the notification from the RTC 14. The interrupt request is not performed to the CPU 11 in the power saving mode.

If the set time-designated operation commands include the specific time-designated operation command, the CPLD 13 is set to perform the interrupt request in response to the notification from the RTC 14. The interrupt request is performed to the CPU 11 in the power saving mode. The CPU 11 returns back from the power saving mode to the normal operation mode and executes the specific time-designated operation command.

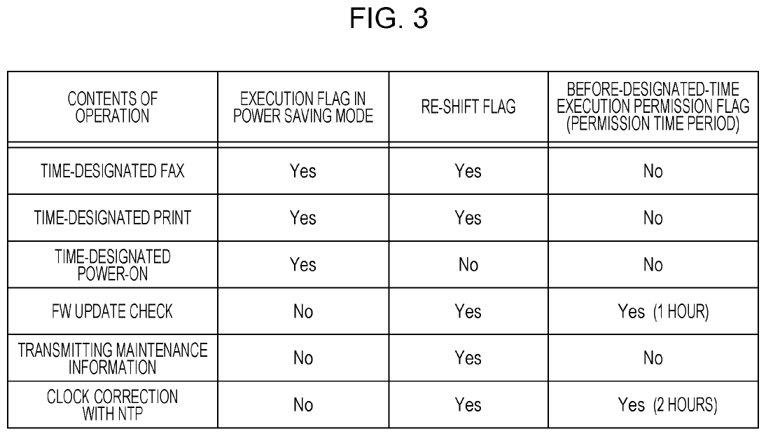

The CPU 11 refers to a setting table of time-designated operation commands in FIG. 3 in order to identify what type of the time-designated operation command that is not set causes the CPLD 13 not to perform the interrupt request in response to the notification from the RTC 14. The setting table of time-designated operation commands is produced in advance and is stored on the storage 16.

The time-designated operation command is described with reference to the setting table of time-designated operation commands in FIG. 3.

The time-designated operation command executes a designated operation at a designated time. For example, the time-designated operation command includes four setting items of contents of operation, execution flag in the power saving mode, re-shift flag, and before-designated-time execution permission flag.

The contents of the operation indicate contents of the operation that is performed when the designated time of the time-designated operation command has arrived. For example, listed in the contents of the operation are a time-designated fax, time-designated print, time-designated power-on, firmware (FW) update check, transmitting maintenance information, clock correction in accordance with network time protocol (NTP).

The execution flag in the power saving mode is used to set whether to execute the time-designated operation command when the designated time of the time-designated operation command has arrived with the image forming apparatus 10 in the power saving mode. Specifically, the time-designated operation command with “yes” set for the execution flag in the power saving mode corresponds to a “specific time-designated operation command” in the exemplary embodiment.

The re-shift flag is used to set whether to re-shift to the power saving mode after performing the time-designated operation command in the normal operation mode when the designated time of the time-designated operation command has arrived with the image forming apparatus 10 in the power saving mode.

The before-designated-time execution permission flag is used to set whether to execute the time-designated operation command even before the designated time if the image forming apparatus 10 returns from the power saving mode to the normal operation mode. For the time-designated operation command with the flag set to yes, a permission time period before the designated time throughout which the execution of the operation is permitted may further be set.

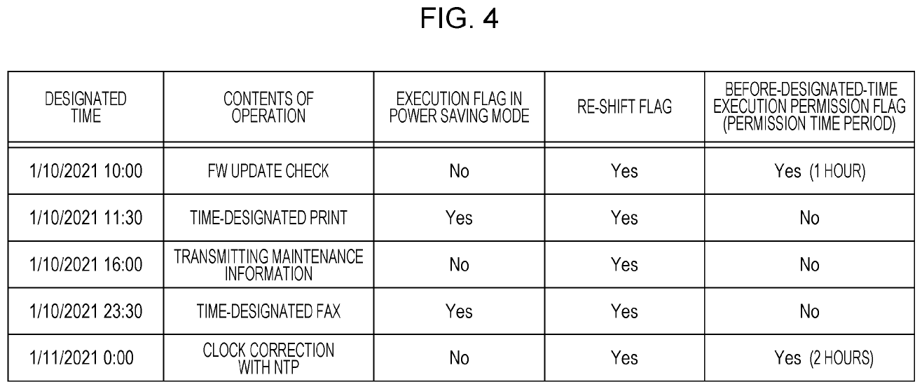

If a user has set the time-designated operation command, the CPU 11 registers the time-designated operation command set by the user in a time-designated operation command list in the order of designated time as illustrated in FIG. 4. The time-designated operation command list is stored on the memory 12. The CPU 11 sets the RTC 14 such that the notification is transmitted at the designated time of the time-designated operation command.

If the time-designated operation command with the execution flag set to yes in the power saving mode is not registered in the time-designated operation command list when the instruction to shift to the power saving mode is received, the CPU 11 sets the CPLD 13 such that the CPLD 13 does not perform an interrupt request in response to a notification from the RTC 14.

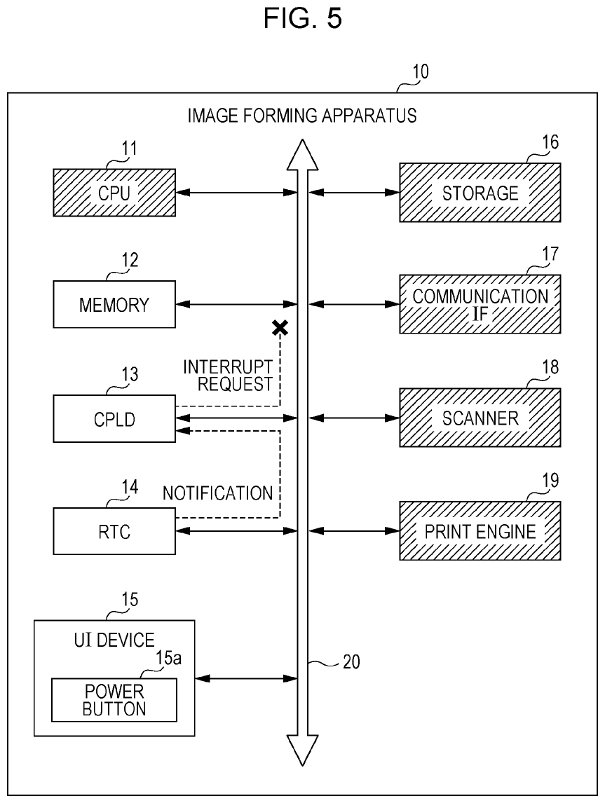

FIG. 5 is a block diagram illustrating a process flow of the image forming apparatus 10 in the power saving mode. Referring to FIG. 5, the CPLD 13 is set not to perform the interrupt request in response to the notification from the RTC 14. In FIG. 5, elements not powered are denoted by hatched boxes.

The CPLD 13 may be set not to perform the interrupt request in response to the notification from the RTC 14. The CPLD 13 does not transmit the interrupt request to the CPU 11 if the notification is transmitted from the RTC 14 to the CPLD 13 as illustrated in FIG. 5 when the designated time of the time-designated operation command has arrived with the image forming apparatus 10 in the power saving mode. The CPU 11 does not return from the power saving mode to the normal operation mode.

If the time-designated operation command with the execution flag in the power saving mode set to yes is registered in the time-designated operation command list when the instruction to shift to the power saving mode is received, the CPU 11 sets the CPLD 13 such that the CPLD 13 performs the interrupt request in response to the notification from the RTC 14.

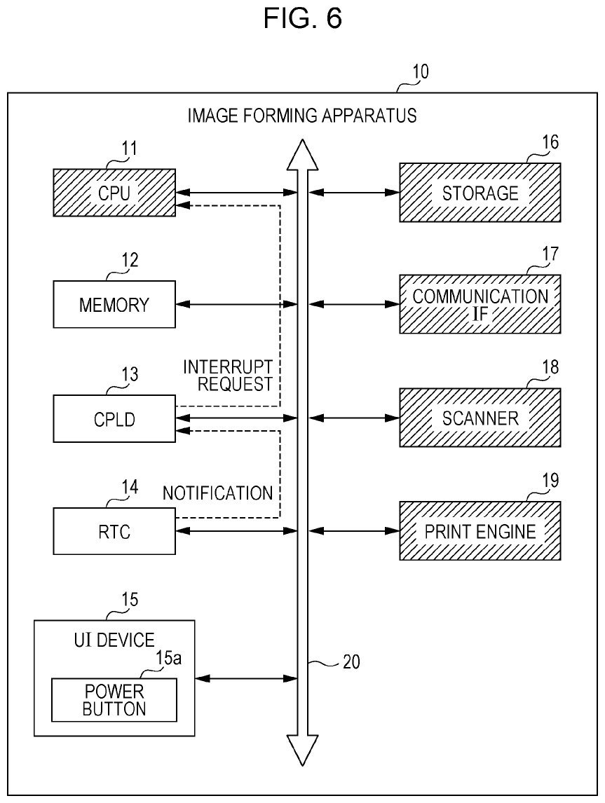

FIG. 6 is a block diagram illustrating the process flow of the image processing apparatus in the power saving mode. Referring to FIG. 6, the CPLD 13 is set to perform the interrupt request in response to the notification from the RTC 14. In FIG. 6, elements not powered are denoted by hatched boxes.

The CPLD 13 may be set to perform the interrupt request in response to the notification from the RTC 14. If the notification is transmitted from the RTC 14 to the CPLD 13 as illustrated in FIG. 6 when the designated time of the time-designated operation command has arrived with the image forming apparatus 10 in the power saving mode, the CPLD 13 transmits the interrupt request to the CPU 11. Upon receiving the interrupt request, the CPU 11 returns from the power saving mode to the normal operation mode and executes the set time-designated operation command.

If the image forming apparatus 10 returns from the power saving mode to execute the time-designated operation command, the CPU 11 shifts again to the power saving mode after executing the time-designated operation command serving as a return trigger. According to the exemplary embodiment, the CPU 11 references the re-shift flag of the time-designated operation command serving as a return trigger. If the re-shift flag of the time-designated operation command serving as the return trigger is yes, the CPU 11 shifts again to the power saving mode after executing the time-designated operation command serving as the return trigger.

The CPU 11 may shift again to the power saving mode after executing not only the time-designated operation command serving as the return trigger but also a time-designated operation command set at time within a predetermined time period from the return. According to the exemplary embodiment, the CPU 11 references the time-designated operation command list. If there is a time-designated operation command having the before-designated-time execution permission flag being yes and being within the permission time period from the present time to the designated time, the CPU 11 shifts again to the power saving mode after executing that time-designated operation command.

For example, the image forming apparatus 10 may now be in the normal operation mode returning from the power saving mode in order to execute the time-designated fax at designated time Jan. 10, 2021, 23:30 in the time-designated operation command list in FIG. 4. In the time-designated operation command list, “clock correction with network time protocol (NTP)” designated at Jan. 11, 2021, 00:00 is registered within the permission time period from the present time to the designated time from among the time-designated operation commands registered after the time-designated fax serving as the return trigger. In this case, the CPU 11 shifts again to the power saving mode after executing the time-designated fax serving the return trigger and further the clock correction with NTP.

If the image forming apparatus 10 returns from the power saving mode to execute the time-designated operation command, the CPU 11 may shift again to the power saving mode after executing only the time-designated operation command serving as the return trigger.

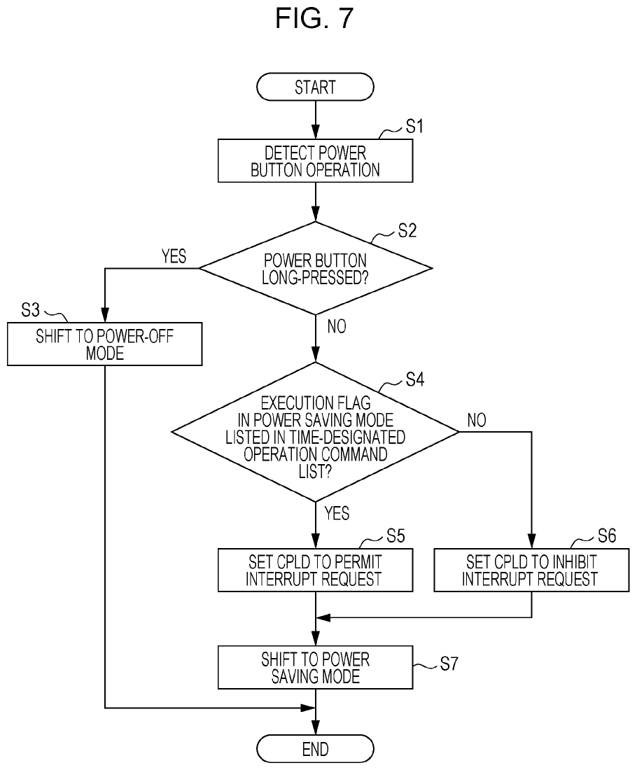

The process flow performed with the power button 15a pressed on the image forming apparatus 10 is described with reference to a flowchart in FIG. 7.

When the operation of the power button 15a is detected in step S1, the CPU 11 determines in step S2 whether the power button 15a is long-pressed. The long-pressing of the power button 15a signifies that the power button 15a has been continuously pressed for a preset time period. For example, if the power button 15a has been continuously pressed for 2 seconds or longer, the CPU 11 determines that the power button 15a is long-pressed.

If the power button 15a is determined to be long-pressed in step S2 (yes path), the CPU 11 causes the image forming apparatus 10 to shift to the power saving mode in step S3.

If the power button 15a is not long-pressed (no path), namely, the UI device 15 is short-pressed in step S2, the CPU 11 determines in step S4 whether an execution flag in the power saving mode is listed in the time-designated operation command list.

If step S4 determines that an execution flag in the power saving mode is listed in the time-designated operation command list (yes path), the CPU 11 sets the CPLD 13 in step S5 to permit the interrupt request. In step S7, the CPU 11 causes the image forming apparatus 10 to shift to the power saving mode and thus ends the process.

If a time-designated operation command that is to be executed during the power saving mode of the image forming apparatus 10 is present, the CPLD 13 transmits the interrupt request to the CPU 11 at the set time of the time-designated operation command. The CPU 11 may thus restore the image forming apparatus 10 from the power saving mode to the normal operation mode at the set time of the time-designated operation command and execute the time-designated operation command.

If step S4 determines that no execution flag in the power saving mode is listed in the time-designated operation command list (no path), the CPU 11 sets the CPLD 13 in step S6 to inhibit the interrupt request. In step S7, the CPU 11 causes the image forming apparatus 10 to shift to the power saving mode and thus ends the process.

If there is not any time-designated operation command that is to be executed during the power saving mode of the image forming apparatus 10, the CPLD 13 does not transmit the interrupt request to the CPU 11 even when the designated time of a time-designated operation command that is to be executed has arrived. The image forming apparatus 10 does not return from the power saving mode to the normal operation mode.

According to the exemplary embodiment, the execution flag in the power saving mode is preset on a per operation content basis in the setting table of the time-designated operation command list in FIG. 3. The CPU 11 may be configured to, in response to an operation of the user, switch the type of a time-designated operation command set to be as a specific time-designated operation command from among multiple time-designated operation commands. Specifically, the execution flag in the power saving mode for each operation content in the setting table of the time-designated operation commands may be switched between yes and no in response to the operation of the user.

The CPU 11 may be configured to, when a new time-designated operation command is set, receive an indication as to whether that the new time-designated operation command is set to be a specific time-designated operation command. When the time-designated operation command is set by the user, the user may set, to any status, namely, yes or no, the execution flag in the power saving mode for the operation content of the time-designated operation command. Modifications

The image forming system of the exemplary embodiment of the disclosure has been described. The disclosure is not limited to the image forming system described above and may be appropriately modified.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

According to the exemplary embodiment, the disclosure is applied to the image forming apparatus. The disclosure is not limited to the image forming apparatus and may be applied to a variety of apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive a first time-designated operation setting to execute a first designated operation at a first designated time; and
shift from a normal operation mode to a power saving mode based on an instruction,
wherein the processor is configured to, if the first designated operation is not a predetermined operation, control to not return from the power saving mode to the normal operating mode to execute the first designated operation at arrival of the first designated time.

2. The information processing apparatus according to claim 1, wherein the processor is configured to, if the first designated operation is the predetermined operation, return from the power saving mode to the normal operation mode to execute the first designated operation at the arrival of the first designated time.

3. The information processing apparatus according to claim 2, wherein the processor is configured to, if the normal operation mode returns from the power saving mode to execute a time-designated operation command, shift to the power saving mode again after performing the time-designated operation command serving as a trigger of return.

4. The information processing apparatus according to claim 3, wherein the processor is configured to, if the normal operation mode returns from the power saving mode to execute the time-designated operation command, shift to the power saving mode again after performing only the time-designated operation command serving as a trigger of return.

5. The information processing apparatus according to claim 3, wherein the processor is configured to, if the normal operation mode returns from the power saving mode to execute the time-designated operation command, shift to the power saving mode again after performing the time-designated operation command serving as the trigger of the return and a time-designated operation command set at a time within a predetermined time period from the return.

6. The information processing apparatus according to claim 1, wherein the processor is configured to, in response to an operation of a user, change a type of a time-designated operation command that is set as a specific time-designated operation command, from among a plurality of time-designated operation commands.

7. The information processing apparatus according to claim 2, wherein the processor is configured to, in response to an operation of a user, change a type of a time-designated operation command that is set as a specific time-designated operation command, from among a plurality of time-designated operation commands.

8. The information processing apparatus according to claim 3, wherein the processor is configured to, in response to an operation of a user, change a type of a time-designated operation command that is set as a specific time-designated operation command, from among a plurality of time-designated operation commands.

9. The information processing apparatus according to claim 4, wherein the processor is configured to, in response to an operation of a user, change a type of a time-designated operation command that is set as a specific time-designated operation command, from among a plurality of time-designated operation commands.

10. The information processing apparatus according to claim 5, wherein the processor is configured to, in response to an operation of a user, change a type of a time-designated operation command that is set as a specific time-designated operation command, from among a plurality of time-designated operation commands.

11. The information processing apparatus according to claim 1, wherein the processor is configured to, when a new time-designated operation command is set, receive an indication as to whether the new time-designated operation command is to be set as a specific time-designated operation command.

12. The information processing apparatus according to claim 2, wherein the processor is configured to, when a new time-designated operation command is set, receive an indication as to whether the new time-designated operation command is to be set as a specific time-designated operation command.

13. The information processing apparatus according to claim 3, wherein the processor is configured to, when a new time-designated operation command is set, receive an indication as to whether the new time-designated operation command is to be set as a specific time-designated operation command.

14. The information processing apparatus according to claim 4, wherein the processor is configured to, when a new time-designated operation command is set, receive an indication as to whether the new time-designated operation command is to be set as a specific time-designated operation command.

15. The information processing apparatus according to claim 5, wherein the processor is configured to, when a new time-designated operation command is set, receive an indication as to whether the new time-designated operation command is to be set as a specific time-designated operation command.

16. A non-transitory computer readable medium storing a program causing a computer to execute a process, the process comprising:
receiving a first time-designated operation setting to execute a first designated operation at a first designated time; and
shifting from a normal operation mode to a power saving mode based on an instruction,
wherein the processor is configured to, if the first designated operation is not a predetermined operation, control to not return from the power saving mode to the normal operating mode to execute the first designated operation at arrival of the first designated time.

17. An information processing method of an information processing apparatus, comprising:
receiving a first time-designated operation setting to execute a first designated operation at a first designated time; and
shifting from a normal operation mode to a power saving mode based on an instruction,
wherein the processor is configured to, if the first designated operation is not a predetermined operation, control to not return from the power saving mode to the normal operating mode to execute the first designated operation at arrival of the first designated time.
